(19) United States
(12) Patent Application Publication
(10) Pub. No.: US 2019/0134920 A1
(43) Pub. Date: May 9, 2019

(54) FIBER-REINFORCED THERMOPLASTIC RESIN MEMBER WELDING METHOD AND WELDING DEVICE

(71) Applicant: TOYOTA JIDOSHA KABUSHIKI KAISHA, Toyota-shi (JP)

(72) Inventor: Yoshihiro IWANO, Toyota-shi (JP)

(73) Assignee: TOYOTA JIDOSHA KABUSHIKI KAISHA, Toyota-shi (JP)

(21) Appl. No.: 16/173,294

(22) Filed: Oct. 29, 2018

(30) Foreign Application Priority Data
Nov. 9, 2017 (JP) 2017-216182

(51) Int. Cl. B29C 65/34; B29C 65/22; B29C 65/00; B29C 65/24

(52) U.S. Cl. CPC B29C 65/3424; B29C 65/222; B29C 66/7212; B29C 65/242; B29C 66/73921; B29C 66/71

(57) ABSTRACT

A fiber-reinforced thermoplastic resin member welding method includes: heating, by a heating unit, a welding target portion in which plural fiber-reinforced thermoplastic resin members layered on top of each other, each of the plural fiber-reinforced thermoplastic resin members including thermoplastic resin as a main composition, and the thermoplastic resin including reinforcing fibers; applying pressure, by a pressure applying unit, to the welding target portion; and cooling, by a cooling unit, at least a surface of the welding target portion at the same time as when the welding target portion is being heated by the heating unit or after the welding target portion has been heated by the heating unit.

### CROSS-REFERENCE TO RELATED APPLICATION

This application is based on and claims priority under 35 USC 119 from Japanese Patent Application No. 2017-216182 filed on Nov. 9, 2017, the disclosure of which is incorporated by reference herein.

### BACKGROUND

### Technical Field

The present disclosure relates to a fiber-reinforced thermoplastic resin member welding method and a fiber-reinforced thermoplastic resin member welding device.

### Related Art

Japanese Patent Application Laid-open (JP-A) No. 2004-160675 discloses a welding method in which, when making a resin product by welding a part made of thermoplastic resin to a product body made of thermoplastic resin, welding is performed in a state in which a thermoplastic resin film having a larger area than the welding region is interposed in a welding portion.

When welding a welding target portion in which plural fiber-reinforced thermoplastic resin members are layered on top of each other by heating with a heating unit, in order to ensure the shear strength of the welded portion, it is necessary to sufficiently heat and melt the welding target portion.

However, when the heating temperature is raised in order to sufficiently heat the welding target portion of the fiber-reinforced thermoplastic resin members, the temperature of the surface away from the welding surfaces also becomes higher because of heat transmitted by the reinforcement fibers. Therefore, in a method in which natural cooling is performed subsequent to the heating of the welding target portion, there is the potential for the temperature of the surface of part of the welding target portion to exceed the melting temperature and for appearance defects such as surface swelling to arise.

Namely, when welding plural fiber-reinforced thermoplastic resin members to each other by heating them with a heating unit, in a method that performs just natural cooling for cooling subsequent to the heating, there is room for improvement to reduce defects in the appearance of the welding target portion while ensuring the shear strength of the welded portion of the welding target portion.

### SUMMARY

In consideration of the above-described circumstances, the present disclosure provides a fiber-reinforced thermoplastic resin member welding method and welding device that may reduce defects in the appearance of the welding target portion while ensuring the shear strength of the welded portion of the welding target portion when welding plural fiber-reinforced thermoplastic resin members to each other by heating them with a heating unit, compared to a method that performs only natural cooling for cooling subsequent to the heating.

A first aspect of the disclosure is a fiber-reinforced thermoplastic resin member welding method including: heating, by a heating unit, a welding target portion in which a plurality of fiber-reinforced thermoplastic resin members layered on top of each other, each of the plurality of fiber-reinforced thermoplastic resin members including thermoplastic resin as a main composition, and the thermoplastic resin including reinforcing fibers; applying pressure, by a pressure applying unit, to the welding target portion; and cooling, by a cooling unit, at least a surface of the welding target portion at the same time as when the welding target portion is being heated by the heating unit or after the welding target portion has been heated by the heating unit.

In the first aspect, the welding target portion of the plural fiber-reinforced thermoplastic resin members is welded as a result of being melted by the heat applied by the heating unit and, therefore, the shear strength of the welded portion of the welding target portion may be ensured. In addition, expansion accompanying the rise in the temperature of the fiber-reinforced thermoplastic resin members is suppressed by the pressure applied by the pressure applying unit. Moreover, since at least the surface of the welding target portion is cooled by the cooling unit, the temperature of the surface is kept from becoming higher than the temperature of the welded portion. As a result of these operations, appearance defects such as swelling of the surface of the welding target portion may be reduced. Namely, in the first aspect, when welding the plural fiber-reinforced thermoplastic resin members to each other by heating them with the heating unit, defects in the appearance of the welding target portion may be reduced while ensuring the shear strength of the welded portion of the welding target portion, compared to a method that performs only natural cooling for cooling subsequent to the heating. It should be noted that the “welding target portion” refers to the entire portion in which the plural fiber-reinforced thermoplastic resin members are layered on top of each other, regardless of whether or not it is welded. Furthermore, the “welded portion” is part of the welding target portion and refers to the portion that has been welded including welding surfaces and areas around the welding surfaces.

In the first aspect, the cooling may include cooling the welding target portion by cooling the pressure applying unit by the cooling unit.

In this configuration, the pressure applying unit is cooled by the cooling unit. When applying pressure to the welding target portion, the cooled pressure applying unit is brought into contact with the welding target portion, whereby at least the surface of the welding target portion is cooled. In this way, since the surface of the welding target portion is cooled utilizing the contact between the pressure applying unit and the welding target portion, the efficiency with which the surface of the welding target portion is cooled may be raised, compared to a method in which the cooling is performed by the cooling unit without contacting the surface of the welding target portion.

In the first aspect, the pressure applying unit may include a pressure applying member provided with a hollow portion, and the cooling may include cooling the hollow portion by the cooling unit.

In this configuration, the hollow portion of the pressure applying member is cooled by the cooling unit, whereby the pressure applying member is cooled. In other words, the cooling unit cools the pressure applying unit from inside. Because of this, the space needed for cooling the pressure applying member may be reduced compared to a method in which the cooling unit cools the pressure applying member from outside.

In the first aspect, the cooling may include cooling the surface of the welding target portion by blowing, by the cooling unit, air toward a portion being heated by the heating unit.

In the above-described configuration, air is blown by the cooling unit toward the portion being heated by the heating unit, whereby the surface of the welding target portion is cooled. As a result, cooling of the surface of the welding target portion is started at an earlier time compared to a method in which the surface of the welding target portion is cooled subsequent to the heating and, thus, the temperature that the surface of the welding target portion reaches may be lowered.

In the first aspect, the welding target portion may extend in an intersecting direction intersecting the layering direction of the plurality of fiber-reinforced thermoplastic resin members, the heating unit, the pressure applying unit, and the cooling unit may be disposed at one side of the welding target portion in the layering direction, and the method may further include performing the heating of the welding target portion, the application of pressure to the welding target portion, and the cooling of the welding target portion while moving, by a moving unit, the heating unit, the pressure applying unit, and the cooling unit, integrally in the intersecting direction.

In the above configuration, the heating of the welding target portion, the application of pressure to the welding target portion, and the cooling of the welding target portion are performed while the heating unit, the pressure applying unit, and the cooling unit disposed on the one side of the welding target portion in the layering direction are moved integrally in the intersecting direction by the moving unit. As a result, the plural fiber-reinforced thermoplastic resin members do not need to be moved, and the space needed for welding the welding target portion may be reduced compared to a method in which the plural fiber-reinforced thermoplastic resin members are moved.

A second aspect of the disclosure is a fiber-reinforced thermoplastic resin member welding device including: a heating unit that is configured to heat a welding target portion in which a plurality of fiber-reinforced thermoplastic resin members are layered on top of each other, each of the plurality of fiber-reinforced thermoplastic resin members including thermoplastic resin as a main composition, and the thermoplastic resin including reinforcing fibers; a pressure applying unit that is configured to apply pressure to the welding target portion at the same time as when the welding target portion is being heated by the heating unit or after the welding target portion has been heated by the heating unit; and a cooling unit that is configured to cool at least a surface of the welding target portion.

In the second aspect, since the welding target portion of the plural fiber-reinforced thermoplastic resin members is welded as a result of being melted by the heat applied by the heating unit, the shear strength of the welded portion of the welding target portion may be ensured. In addition, expansion accompanying the rise in the temperature of the fiber-reinforced thermoplastic resin members is suppressed by the pressure applied by the pressure applying unit. Moreover, since at least the surface of the welding target portion is cooled by the cooling unit, the temperature of the surface is kept from becoming higher than the temperature of the welded portion. As a result of these operations, appearance defects such as swelling of the surface of the welding target portion may be reduced. Namely, in the second aspect, when welding the plural fiber-reinforced thermoplastic resin members to each other by heating them with the heating unit, defects in the appearance of the welding target portion may be reduced while ensuring the shear strength of the welded portion of the welding target portion, compared to a configuration that performs only natural cooling for cooling subsequent to the heating. It should be noted that the “welding target portion” refers to the entire portion in which the plural fiber-reinforced thermoplastic resin members are layered on top of each other, regardless of whether or not it is welded. Furthermore, the “welded portion” refers to part of the welding target portion and means the portion that has been welded including welding surfaces and areas around the welding surfaces.

In the second aspect, the pressure applying unit may include a pressure applying member that applies pressure to the welding target portion, and the cooling unit may be configured to cool at least the surface of the welding target portion by cooling the pressure applying member.

In this configuration, the pressure applying member is cooled by the cooling unit. When applying pressure to the welding target portion, the cooled pressure applying member is brought into contact with the welding target portion, whereby at least the surface of the welding target portion is cooled. In this way, since the surface of the welding target portion is cooled utilizing the contact between the pressure applying member and the welding target portion, the efficiency with which the surface of the welding target portion is cooled may be raised compared to a configuration in which the cooling is performed by the cooling unit without contacting the surface of the welding target portion.

In the second aspect, the pressure applying member may include a pressure applying rotor that is provided with a hollow portion and applies pressure to the welding target portion while rotating, and the cooling unit may include a conducting component that is configured to conduct, through the hollow portion, a coolant that cools the pressure applying member.

In this configuration, the coolant is conducted through the inside of the hollow portion of the pressure applying rotor by the conducting component, whereby the pressure applying member is cooled. In other words, the cooling unit cools the pressure applying member from inside with the coolant. As a result, the space needed for cooling the pressure applying member may be reduced compared to a configuration in which the cooling unit cools the pressure applying member from outside.

In the second aspect, wherein the cooling unit may include an air blowing unit that is configured to cool the surface of the welding target portion by blowing air toward a portion being heated by the heating unit.

In this configuration, air is blown from the air blowing unit toward the portion being heated by the heating unit, whereby the surface of the welding target portion is cooled. As a result, cooling of the surface of the welding target portion is started at an earlier time compared to a method in which the surface of the welding target portion is cooled subsequent to the heating and, thus, the temperature that the surface of the welding target portion reaches may be lowered.

In the second aspect, the welding target portion may extend in an intersecting direction intersecting the layering direction of the plurality of fiber-reinforced thermoplastic resin members, the heating unit, the pressure applying unit, and the cooling unit may be disposed at one side of the welding target portion in the layering direction, and the device may further include a moving unit that is configured to move the heating unit, the pressure applying unit, and the cooling unit, integrally in the intersecting direction

In the above configuration, the heating of the welding target portion, the application of pressure to the welding target portion, and the cooling of the welding target portion are performed while the heating unit, the pressure applying unit, and the cooling unit disposed on the one side of the welding target portion in the layering direction are moved integrally in the intersecting direction by the moving unit. As a result, since the plural fiber-reinforced thermoplastic resin members do not need to be moved, the space needed for welding the welding target portion may be reduced compared to a method in which the plural fiber-reinforced thermoplastic resin members are moved.

The technology of the present disclosure may reduce defects in the appearance of the welding target portion while ensuring the shear strength of the welded portion of the welding target portion when welding plural fiber-reinforced thermoplastic resin members to each other by heating them with a heating unit, compared to a method that performs only natural cooling for cooling subsequent to the heating.

### BRIEF DESCRIPTION OF THE DRAWINGS

FIG. 1 is a plan drawing illustrating a configuration of a welding device pertaining to a first embodiment;

FIG. 2A is an enlarged explanatory drawing illustrating a heating unit, a pressure applying unit, and a cooling unit of the welding device pertaining to the first embodiment;

FIG. 2B is an explanatory drawing illustrating, in a simplified way, carbon fibers in a resin member pertaining to the first embodiment;

FIG. 3A is an explanatory drawing illustrating the heating of a welding target portion by the heating unit pertaining to the first embodiment;

FIG. 3B is an explanatory drawing illustrating the application of pressure to the welding target portion by the pressure applying unit, and the cooling of the welding target portion by the cooling unit pertaining to the first embodiment;

FIG. 3C is an explanatory drawing illustrating the welding target portion pertaining to the first embodiment being naturally cooled;

FIG. 3D is a graph illustrating the relationship between time and the temperature of a welding surface of the welding target portion pertaining to the first embodiment;

FIG. 4A is a graph illustrating the shear stress of test pieces A obtained with the welding device pertaining to the first embodiment;

FIG. 4B is a graph illustrating the shear stress of test pieces B obtained with the welding device pertaining to the first embodiment;

FIG. 5A is a table illustrating appearance evaluation results for the test pieces A obtained with the welding device pertaining to the first embodiment and appearance evaluation results for test pieces of comparative examples;

FIG. 5B is a table illustrating appearance evaluation results for the test pieces B obtained with the welding device pertaining to the first embodiment and appearance evaluation results for test pieces of comparative examples;

FIG. 6 is an enlarged explanatory drawing illustrating a heating unit, a pressure applying unit, and a cooling unit of a welding device pertaining to a second embodiment;

FIG. 7 is a configuration drawing of a heating unit, a cooling unit, and a pressure applying unit of a welding device pertaining to a third embodiment;

FIG. 8A is an explanatory drawing illustrating a configuration of a welding device pertaining to a first example modification; and

FIG. 8B is an explanatory drawing illustrating a configuration of a welding device pertaining to a second example modification.

### DETAILED DESCRIPTION

### First Embodiment

An example of a fiber-reinforced thermoplastic resin member welding method and a fiber-reinforced thermoplastic resin member welding device pertaining to a first embodiment will be described.

[Overall Configuration]

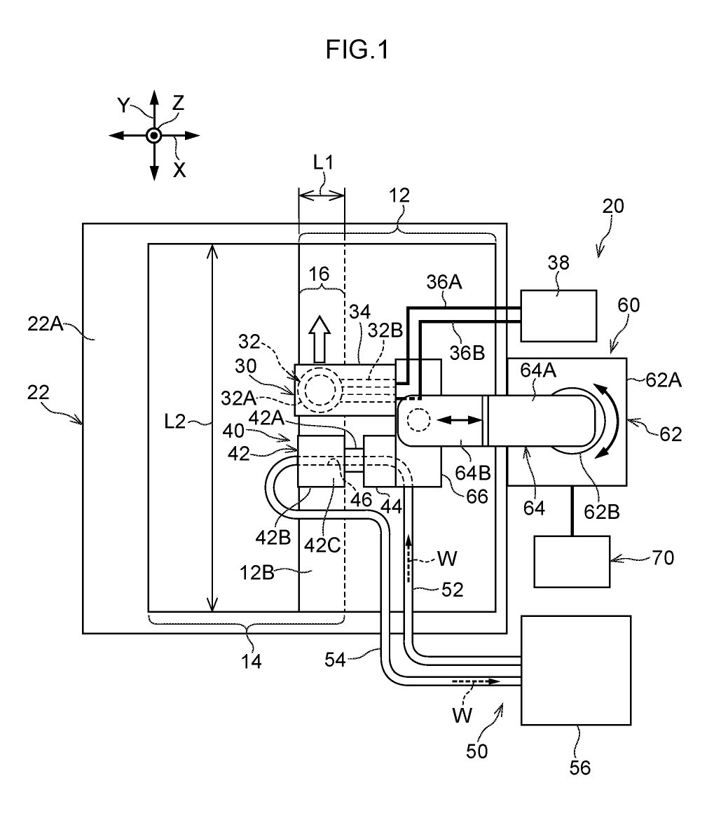

FIG. 1 illustrates a welding device 20 that welds a resin member 12 and a resin member 14 to each other. The resin member 12 and the resin member 14 are examples of plural fiber-reinforced thermoplastic resin members. The welding device 20 is an example of a fiber-reinforced thermoplastic resin member welding device. The resin member 12 and the resin member 14 are, for example, members with the same shape, size, and composition. Therefore, only the resin member 12 will be described, and description of the resin member 14 will be omitted.

The resin member 12 is, for example, a panel member formed in a rectangular shape when viewed in a plan view. In the following description, the widthwise direction of the resin member 12 will be called the X direction, the lengthwise direction of the resin member 12 will be called the Y direction, and the thickness direction of the resin member 12 will be called the Z direction. The X direction, the Y direction, and the Z direction are orthogonal to each other. The Z direction is an example of a layering direction of the fiber-reinforced thermoplastic resin members. The Y direction is an example of an intersecting direction to the layering direction.

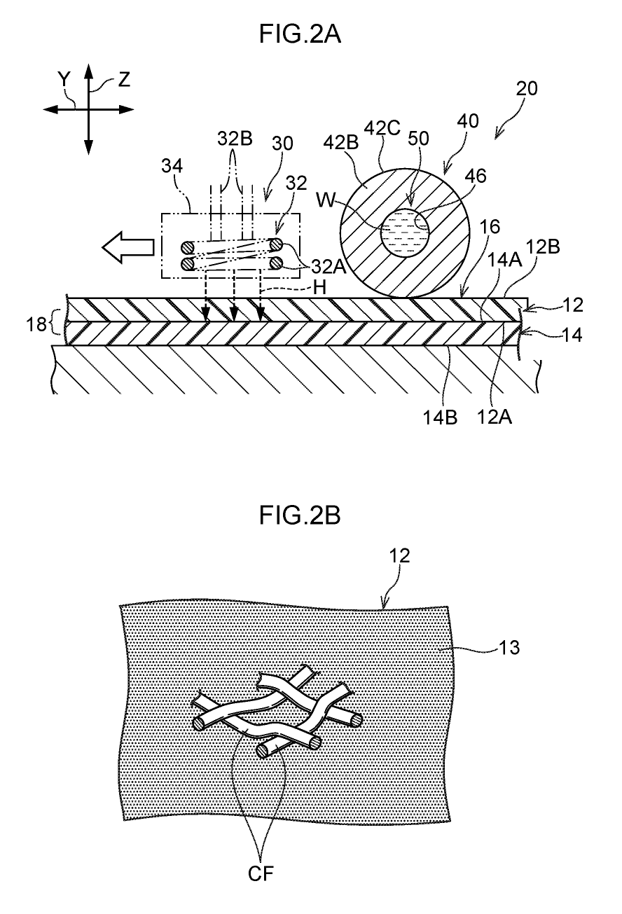

As illustrated in FIG. 2B, the resin member 12 includes thermoplastic resin 13 that is a main composition (base material) and carbon fibers CF that serve as an example of reinforcing fibers. The resin member 12 is formed in a tabular shape as a result of being molded by a molding machine (not illustrated in the drawings). Namely, in the first embodiment, carbon fiber reinforced plastic (CFRP) is used as the resin member 12. A polyamide resin is used for the thermoplastic resin 13, for example. It will be noted that the plural carbon fibers CF are complexly intertwined, but in FIG. 2B the plural carbon fibers CF are illustrated in a simplified way as being intertwined in the form of a lattice.

As illustrated in FIG. 1, the end portion of the resin member 12 on one side in the X direction and the end portion of the resin member 14 on the other side in the X direction are layered (overlapped) on top of each other in the Z direction. This portion in which the resin member 12 and the resin member 14 are layered with each other is referred to as a welding target portion 16. The welding target portion 16 has, for example, a rectangular shape whose widthwise direction coincides with the X direction and whose lengthwise direction coincides with the Y direction when viewed from the Z direction. In other words, the welding target portion 16 extends in the Y direction. L1 denotes the length of the welding target portion 16 in the X direction and L2 denotes the length of the welding target portion 16 in the Y direction.

At the welding target portion 16 illustrated in FIG. 2A, the resin member 12 is layered onto the resin member 14. The surface of the resin member 12 that is the lower side in the Z direction and contacts the resin member 14 is referred to as a welding surface 12A. The surface of the resin member 12 that is the upper side in the Z direction and is positioned at the opposite side of the welding surface 12A in the Z direction is referred to as a surface 12B. The surface of the resin member 14 that is the upper side in the Z direction and contacts the resin member 12 is referred to as a welding surface 14A. The surface of the resin member 14 that is the lower side in the Z direction and is positioned at the opposite side of the welding surface 14A in the Z direction is referred to as a surface 14B.

Here, the “welding target portion 16” refers to the entirety of the portion in which the resin member 12 and the resin member 14 are layered with each other (the entirety of the portion at which welding is to be performed when viewed from the Z direction), regardless of whether or not it is welded. Furthermore, the welding target portion 16 includes not only the welding surface 12A and the welding surface 14A but also the surface 12B and the surface 14B. The portion of the welding target portion 16 that includes the welding surface 12A and the welding surface 14A and areas around the welding surface 12A and the welding surface 14A, and that has been welded by the welding process is referred to as a welded portion 18. In other words, the welded portion 18 configures part of the welding target portion 16 after the welding process.

[Configurations of Main Portions]

Next, the welding device 20 will be described.

The welding device 20 illustrated in FIG. 1 includes, for example, a table 22, a heating unit 30, a pressure applying unit 40, a cooling unit 50, a moving unit 60, and a control unit 70. The table 22 includes an upper surface 22A that extends in the X direction and the Y direction. The upper surface 22A is a flat surface on which the resin member 12 and the resin member 14 are to be placed.

The heating unit 30 is an example of a heating unit. The pressure applying unit 40 is an example of a pressure applying unit. The cooling unit 50 is an example of a cooling unit. The moving unit 60 is an example of a moving unit. Part of the heating unit 30, part of the pressure applying unit 40, and part of the cooling unit 50 are, for example, disposed at one side (the upper side) in the Z direction of the welding target portion 16.

<Heating Unit>

The heating unit 30 includes, for example, a coil member 32, a housing member 34 that houses the coil member 32 inside, and a power supply 38 that supplies a high-frequency current through the coil member 32 to generate a magnetic field around the coil member 32. Namely, the heating unit 30 heats the welding target portion 16 by electromagnetic induction.

The coil member 32 is configured by a coil portion 32A that is formed in a spiral shape and linear portions 32B that extend linearly from one end portion and the other end portion of the coil portion 32A. The coil portion 32A is formed in a circular loop-shape when viewed from the Z direction. Furthermore, the length (diameter) of the outermost diameter of the coil portion 32A when viewed from the Z direction is about the same as the length L1. The coil portion 32A is disposed facing the welding target portion 16 at the upper side of the welding target portion 16 in the Z direction when welding the resin member 12 and the resin member 14 to each other.

One end of a wire 36A and one end of a wire 36B are connected to the end portions of the linear portions 32B at the opposite side of the coil portion 32A side. The power supply 38 is connected to the other ends of the wire 36A and the wire 36B. The power supply 38 is configured to supply the high-frequency current through the coil member 32 when welding the resin member 12 and the resin member 14 to each other.

The housing member 34 is formed in a rectangle shape whose lengthwise direction coincides with the X direction and whose widthwise direction coincides with the Y direction when viewed from the Z direction. Furthermore, the housing member 34 is formed in the shape of a hollow cuboid. As illustrated in FIG. 2A, the coil member 32 is housed inside the housing member 34. The housing member 34 is disposed an interval away from the resin member 12 in the Z direction. The height position of the housing member 34 in the Z direction is set such that a magnetic field H generated when the high-frequency current is supplied through the coil member 32 acts at least on the welding surface 12A and the welding surface 14A of the welding target portion 16.

<Pressure Applying Unit>

The pressure applying unit 40 illustrated in FIG. 1 includes a pressure applying roll 42, which serves as an example of a pressure applying member and a pressure applying rotor, and a support member 44, which supports the pressure applying roll 42. The pressure applying roll 42 is, for example, configured by stainless steel. Furthermore, the pressure applying roll 42 includes a hollow cylinder-shaped shaft portion 42A whose axial direction coincides with the X direction and a hollow cylinder-shaped enlarged-diameter portion 42B whose diameter is enlarged in the radial direction of the shaft portion 42A at the end portion of the shaft portion 42A at the one side in the X direction. The support member 44 rotatably supports the end portion of the shaft portion 42A at the other side in the X direction. The length in the X direction of the enlarged-diameter portion 42B is, for example, substantially the same as the length L1 in the X direction of the welding target portion 16.

As illustrated in FIG. 2A, a hollow portion 46 that extends in the X direction is formed in the rotational center portion of the enlarged-diameter portion 42B. In other words, the pressure applying roll 42 is equipped with the hollow portion 46. The hollow portion 46 is formed in a circular shape when viewed from the X direction. The inner diameter of the hollow portion 46 is smaller than the outer diameter of the shaft portion 42A (see FIG. 1). The hollow portion 46 is formed from the end portion of the enlarged-diameter portion 42B at the one side in the X direction to the end portion of the shaft portion 42A at the other side in the X direction. A pipe member 52 and a pipe member 54 (see FIG. 1) described later are connected to the end portion of the hollow portion 46 at the other side in the X direction and the end portion of the hollow portion 46 at the one side in the X direction, respectively. Water W, described later, is conducted through the hollow portion 46.

When welding the resin member 12 and the resin member 14 to each other at the welding target portion 16, an outer peripheral surface 42C of the enlarged-diameter portion 42B is disposed so as to contact the surface 12B of the resin member 12 of the welding target portion 16. Pressure corresponding to the mass of the enlarged-diameter portion 42B thereby acts on the welding target portion 16. The pressure applying roll 42 is moved by the moving unit 60 (see FIG. 1) described later, so that the pressure applying roll 42 applies pressure to the welding target portion 16 while rotating about its axial direction coinciding with the X direction after the welding target portion 16 has been heated by the heating unit 30.

<Cooling Unit>

The cooling unit 50 illustrated in FIG. 1 includes a pipe member 52 and a pipe member 54, which are flexible and made of resin, and a pump 56, which serves as an example of a conducting component that conducts water W serving as an example of coolant through the pipe member 52 and the pipe member 54. A tank (not illustrated in the drawings) that stores the water W and a pump component (not illustrated in the drawings) that pumps and feeds the water W from the tank are provided inside the pump 56. One end portion of the pipe member 52 and the other end portion of the pipe member 54 are connected to the pump 56. The other end portion of the pipe member 52 is connected to one end portion of the hollow portion 46. One end portion of the pipe member 54 is connected to the other end portion of the hollow portion 46. As a result, when the pump 56 is operated, the water W is conducted continuously through the hollow portion 46.

The pressure applying roll 42 is in contact with the welding target portion 16 in the Z direction. Additionally, the water W is conducted through the hollow portion 46 of the pressure applying roll 42 as a result of the pump 56 being operated. Therefore, when the welding target portion 16 has been heated, the heat of the welding target portion 16 is transmitted to the pressure applying roll 42 and the temperature of the welding target portion 16 falls (i.e., the welding target portion 16 is cooled). Furthermore, the pressure applying roll 42 to which the heat has been transmitted is cooled by the water W flowing through the hollow portion 46. In this way, the cooling unit 50 cools at least the surface 12B of the welding target portion 16 by cooling the pressure applying roll 42 with the water W.

<Moving Unit>

The moving unit 60 includes, for example, an arm rotating unit 62, a movable arm 64, and an attachment member 66.

The arm rotating unit 62 includes a main body 62A that is disposed adjacent to the table 22 and a rotating member 62B that rotates about its axial direction coinciding with the Z direction in the main body 62A. The movable arm 64 includes an extension portion 64A that extends from the rotating member 62B toward the one side (the table 22 side) in the X direction and a movable portion 64B that is provided so as to be capable of protracting and retracting (advancing and retreating) with respect to the extension portion 64A. The attachment member 66 is formed in a cuboid shape whose lengthwise direction coincides with the Y direction.

When the attachment member 66 is viewed from the Z direction, the lengthwise direction central portion of the attachment member 66 is rotatably coupled to the end portion at the protraction side of the movable portion 64B. The angle of the attachment member 66 is adjusted in conjunction with the protraction/retraction of the movable portion 64B so that the lengthwise direction of the attachment member 66 is disposed along the Y direction regardless of the rotational state and protracted/retracted state of the movable arm 64. The other end portion of the housing member 34 is secured to the attachment member 66. The housing member 34 extends from the attachment member 66 toward the one side in the X direction. Furthermore, the other end portion of the support member 44 is secured to the attachment member 66. The support member 44 extends from the attachment member 66 toward the one side in the X direction.

Since the attachment member 66 is moved along the Y direction regardless of the rotational state and the protracted/retracted state of the movable arm 64, the coil portion 32A and the enlarged-diameter portion 42B are moved without shifting their positions in the X direction from the above of the welding target portion 16. In this way, the moving unit 60 moves, integrally in the Y direction, the heating unit 30, the pressure applying unit 40, and the cooling unit 50 disposed at the one side of the welding target portion 16 in the Z direction.

<Control Unit>

The control unit 70 includes, for example, an electronic control unit (ECU), which is not illustrated in the drawings. The ECU is configured by a microcomputer that includes a central processing unit (CPU), a read-only memory (ROM), a random-access memory (RAM) and the like. A program for performing various controls, such as control of the heating in the heating unit 30, control of the cooling by the cooling unit 50, and control of the moving of the moving unit 60 is installed in the control unit 70. The control unit 70 is not limited to that being provided independently of the heating unit 30, the pressure applying unit 40, the cooling unit 50, and the moving unit 60, and may also be configured by a control unit provided in at least one of the heating unit 30, the pressure applying unit 40, the cooling unit 50, and the moving unit 60.

The control unit 70 is configured to perform control of heating the welding target portion 16 by the heating unit 30 and cooling the welding target portion 16 by the cooling unit 50, while controlling the moving component 60 to move the heating unit 30, the pressure applying unit 40, and the cooling unit 50 in the Y direction.

[Operations and Effects]

Next, the operations and effects of the welding device 20 of the first embodiment will be described.

As illustrated in FIG. 1, the welding target portion 16 is formed by the resin member 12 and the resin member 14 being placed on the table 22. Then, the coil portion 32A of the coil member 32 and the enlarged-diameter portion 42B of the pressure applying roll 42 are disposed over the welding target portion 16. The coil portion 32A is disposed away from the surface 12B of the welding target portion 16 in the Z direction. The outer peripheral surface 42C of the enlarged-diameter portion 42B is in contact with the surface 12B. The water W is conducted through the hollow portion 46 of the pressure applying roll 42.

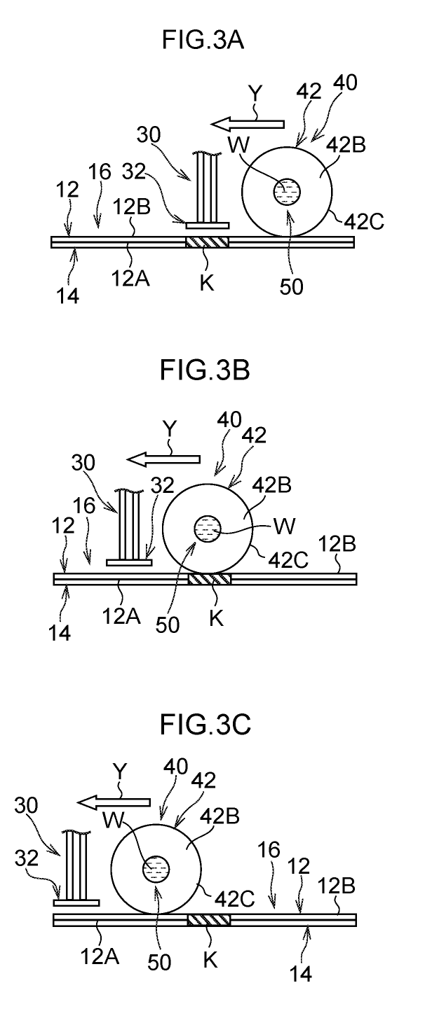

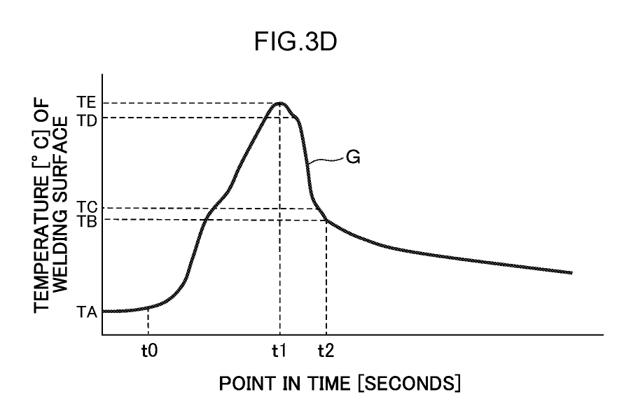

The magnetic field H is generated as a result of the high-frequency current supplied from the power supply 38 (see FIG. 1) through the coil portion 32A illustrated in FIG. 2A. The magnetic field H acts on the welding target portion 16, whereby an induced current arises in the carbon fibers CF (see FIG. 2B) serving as resistors inside the resin member 12 and inside the resin member 14. The carbon fibers CF give off heat because of this induced current, whereby the base material of the resin member 12 and the base material of the resin member 14 are heated. Namely, the welding target portion 16 is heated by the heating unit 30 (an example of a first step). The base material of the resin member 12 and the base material of the resin member 14 are melted by the heat, and the welding surface 12A and the welding surface 14A are welded to each other. The portion of the welding target portion 16 that has finished being heated is referred to as a heated portion K (see FIG. 3A).

As illustrated in FIG. 3A and FIG. 3B, after (immediately after) the heated portion K has been formed, the moving unit 60 (see FIG. 1) is operated, whereby the coil member 32 and the pressure applying roll 42 are moved in the Y direction. As a result, the outer peripheral surface 42C of the pressure applying roll 42 is brought into contact with the surface 12B of the heated portion K. The heated portion K becomes sandwiched between the table 22 (see FIG. 1) and the pressure applying roll 42, whereby pressure is applied in the Z direction to the heated portion K. In other words, pressure is applied by the pressure applying unit 40 to the heated portion K after the heat has been applied by the heating unit 30 (an example of a second step). Expansion of the heated portion K in the Z direction is suppressed due to this application of pressure.

The pressure applying roll 42 is moved in the Y direction, while rotating, by the operation of the moving unit 60 (see FIG. 1). At this time, the temperature the surface 12B of the heated portion K, which has once risen, falls due to the surface 12B contacting with the pressure applying roll 42 and the heat being transmitted to the pressure applying roll 42. The surface 12B is continuously cooled as a result of the pressure applying roll 42 being cooled by the water W. In other words, at least the surface 12B of the welding target portion 16 is cooled by the cooling unit 50 (an example of a third step). As illustrated in FIG. 3C, the heated portion K is naturally cooled after the pressure applying roll 42 has passed over the heated portion K.

FIG. 3D illustrates graph G indicating the relationship between the temperature of the welding surface 12A of the welding target portion 16 (see FIG. 3A) and time. TA denotes the temperature of the welding surface 12A prior to heating, TC denotes the solidification temperature of the resin member 12 (see FIG. 3A), and TD denotes the melting temperature of the resin member 12, where TA<TC<TD. Furthermore, t0 denotes the time when the heating by the heating unit 30 is started, t1 denotes the time when the cooling of the heated portion K by the cooling unit 50 (see FIG. 3B) is started, and t2 denotes the time when the cooling by the cooling unit 50 is ended. TE denotes the temperature of the welding surface 12A at time t1, and TB denotes the temperature of the welding surface 12A at time t2.

As illustrated in FIG. 3A and FIG. 3D, the welding target portion 16 is heated from time t0 to time t1, the temperature of the welding surface 12A thereby rises from TA to TE (>TD), and the heated portion K is formed. The moving unit 60 (see FIG. 1) does not move until just before time t1, and just before time t1 the moving unit 60 starts moving.

Next, as illustrated in FIG. 3B and FIG. 3D, the heated portion K is cooled by the cooling unit 50 from time t1 to time t2, and the temperature of the welding surface 12A thereby falls from TE to TB (TA<TB<TC). As a result of this, the temperature of the surface 12B also reaches a temperature lower than TD.

Next, as illustrated in FIG. 3C and FIG. 3D, from time t2 on, the welding target portion 16 is naturally cooled and the temperature of the welding surface 12A thereby falls below TB at a slower rate of change in temperature than the rate of change in temperature from time t to time t2.

Welding of the welding target portion 16 along the Y direction is performed by the heating step, the pressure application step, and the cooling step being repeated while the moving unit 60 (see FIG. 1) moves. In other words, the welding device 20 illustrated in FIG. 1 performs the heating of the welding target portion 16, the application of pressure to the welding target portion 16, and the cooling of the welding target portion 16 while the heating unit 30, the pressure applying unit 40, and the cooling unit 50 are moved integrally in the Y direction by the moving unit 60.

As described above, in the welding device 20 illustrated in FIG. 1 and FIG. 2A and the welding method using the welding device 20, the welding target portion 16 is welded (solidified) as a result of being sufficiently melted by the heat applied by the heating unit 30. Therefore, the shear strength of the welded portion 18 of the welding target portion 16 may be ensured.

In addition, in the welding device 20, expansion in the Z direction accompanying the rise in the temperature of the resin member 12 and the resin member 14 is suppressed by the pressure applied by the pressure applying unit 40. Moreover, since at least the surface 12B of the welding target portion 16 is cooled by the cooling unit 50, the temperature of the surface 12B is kept from becoming higher than the temperature of the welded portion 18 (the welding surfaces 12A and 14A). Therefore, appearance defects such as swelling of the surface 12B of the welding target portion 16 may be reduced. Namely, when welding the resin member 12 and the resin member 14 to each other by heating them with the heating unit 30, defects in the appearance of the welding target portion 16 may be reduced while ensuring the shear strength of the welded portion 18 of the welding target portion 16 compared to a configuration in which just natural cooling is performed subsequent to the heating.

Furthermore, in the welding device 20 and the welding method using the welding device 20, the pressure applying roll 42 is cooled by the cooling unit 50 (i.e., by the water W). When applying pressure to the welding target portion 16, the cooled pressure applying roll 42 is brought into contact with the welding target portion 16, whereby at least the surface 12B of the welding target portion 16 is cooled. In this way, since the surface 12B of the welding target portion 16 is cooled utilizing the contact between the pressure applying roll 42 and the welding target portion 16, the efficiency with which the surface 12B of the welding target portion 16 is cooled may be raised compared to a configuration in which cooling is performed in a state in which the cooling unit 50 is not in contact with the surface 12B.

Moreover, in the welding device 20 and the welding method using the welding device 20, the pressure applying roll 42 is cooled by the water W conducted through the hollow portion 46 of the pressure applying roll 42 by the pump 56. In other words, the cooling unit 50 cools the pressure applying roll 42 from inside with the water W. Because of this, the space necessary for cooling the pressure applying roll 42 may be reduced compared to a configuration in which the cooling unit 50 cools the pressure applying roll 42 from outside.

In addition, in the welding device 20 and the welding method using the welding device 20, the heating of the welding target portion 16, the application of pressure to the welding target portion 16, and the cooling of the welding target portion 16 are performed while the heating unit 30, the pressure applying unit 40, and the cooling unit 50 disposed at the upper side of the welding target portion 16 in the Z direction are moved integrally in the Y direction by the moving unit 60. Therefore, there is no need to move the resin member 12 and the resin member 14 in the Y direction, and the space (workspace) necessary for welding the welding target portion 16 may be reduced compared to a configuration in which the resin member 12 and the resin member 14 are moved in the Y direction.

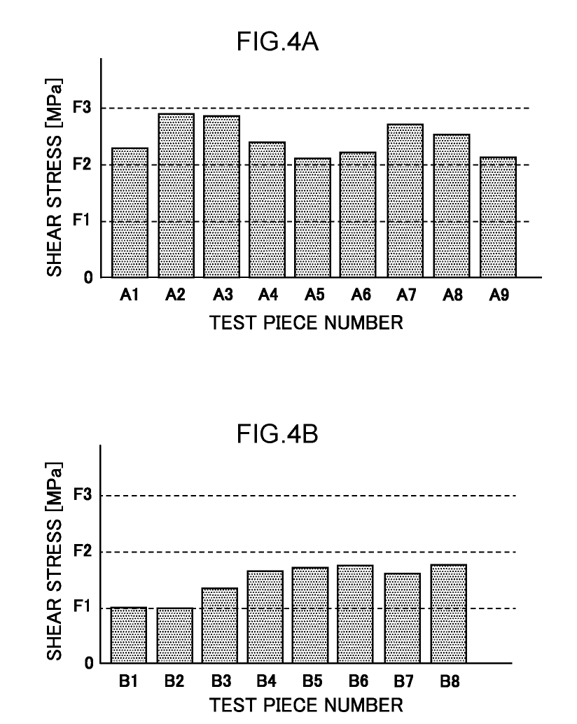

In FIG. 4A, shear stress measurement results for welded portions 18 of test pieces A (nos. A1, A2, A3, A4, A5, A6, A7, A8, and A9) welded by the welding device 20 (see FIG. 1) are illustrated in a bar graph. In FIG. 4B, shear stress measurement results for welded portions 18 of test pieces B (nos. B1, B2, B3, B4, B5, B6, B7, and B8) welded by the welding device 20 (see FIG. 1) are illustrated in another bar graph. The measurement of shear stress was performed using, for example, the Autograph AG-X100KN made by Shimadzu Corporation.

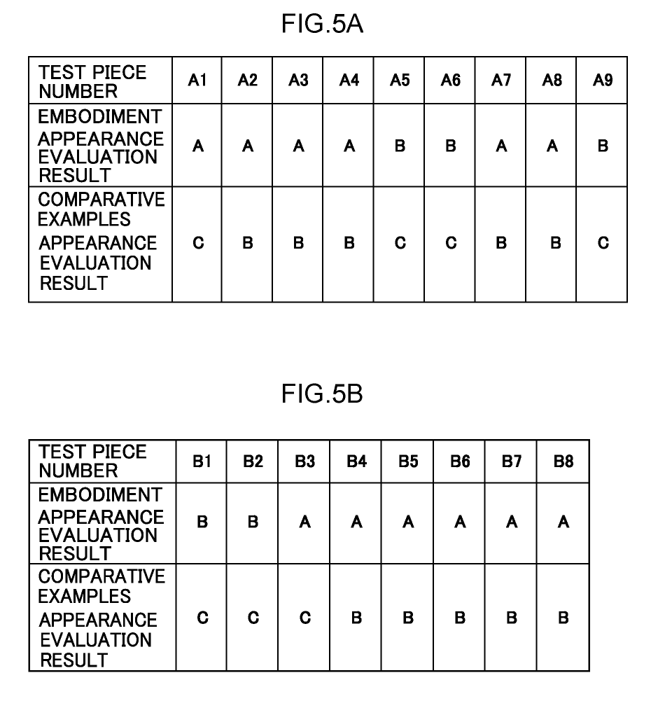

FIG. 5A illustrates appearance evaluation results for the surfaces of the welded portions 18 of the test pieces A together with results for comparative examples (in which the test pieces A were naturally cooled). The appearance evaluation was performed by visual inspection using a three-grade scale, with an A grade indicating that surface swelling and/or air bubbles were hardly visible or not at all visible, a B grade indicating that surface swelling and/or air bubbles were faintly visible but posed no problem, and a C grade indicating that surface swelling and/or air bubbles were clearly visible in multiple places. Namely, the A grade and the B grade are passing grades, while the C grade is a failing grade. FIG. 5B illustrates appearance evaluation results for the surfaces of the welded portions 18 of the test pieces B together with results for comparative examples (in which the test pieces B were naturally cooled). The same appearance evaluation method as the method used for the test pieces A was used.

The test pieces A and the test pieces B have the same base material but the intertwining of the carbon fibers CF (see FIG. 2B) is different. The difference in the numbers assigned to the test pieces A and the test pieces B means that the positions at which the test pieces are cut out in the Y direction are different. In both FIG. 4A and FIG. 4B, the unit of measurement for shear stress is MPa. In FIG. 4A and FIG. 4B, shear stress F refers to the value of shear stress considered to be the required minimum for actual use of the resin member 12 and the resin member 14 (see FIG. 1). Shear stress F2 refers to the value of shear stress preferred for actual use of the resin member 12 and the resin member 14. Shear stress F3 refers to the value of shear stress considered to be sufficient for actual use of the resin member 12 and the resin member 14.

As illustrated in FIG. 4A, regarding the test pieces A, shear stress was greater than F2 in all of A1 to A9. As illustrated in FIG. 5A, in the appearance evaluation of the test pieces A, an A grade was given to A1 to A4, A7, and A8, while a B grade was given to A5, A6, and A9. In contrast, in the appearance evaluation of the comparative examples, a B grade was given to A2 to A4, A7, and A8, while a C grade was given to A1, A5, A6 and A9.

As illustrated in FIG. 4B, regarding the test pieces B, shear stress was equal to or greater than F1 in all of B1 to B8. As illustrated in FIG. 5B, in the appearance evaluation of the test pieces B, an A grade was given to B3 to B8, while a B grade was given to B1 and B2. In contrast, in the appearance evaluation of the comparative examples, a B grade was given to B4 to B8, while a C grade was given to B1 to B3.

As seen above, it has been confirmed that the welding device 20 and the welding method using the welding device 20 may reduce defects in the appearance of the welding target portion 16, while ensuring the shear strength of the welded portion 18 of the welding target portion 16, compared to a configuration that performs only natural cooling subsequent to the heating.

### Second Embodiment

Next, an example of a fiber-reinforced thermoplastic resin member welding method and a fiber-reinforced thermoplastic resin member welding device pertaining to a second embodiment will be described. Members and portions that are basically similar to those in the first embodiment will be assigned the same reference signs as in the first embodiment and description thereof will be omitted.

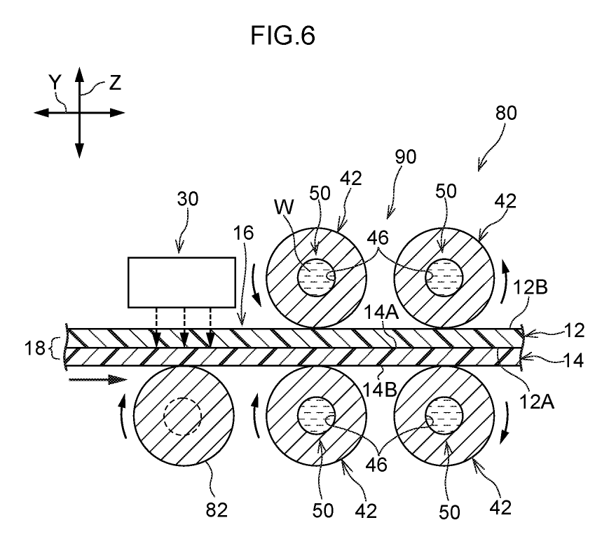

FIG. 6 illustrates a welding device 80 of the second embodiment. The welding device 80 is an example of a fiber-reinforced thermoplastic resin member welding device. The welding device 80 includes, for example, the heating unit 30, a pressure applying unit 90, a support roll 82, and the cooling unit 50. The pressure applying unit 90 is an example of a pressure applying unit. In the welding device 80, the table 22 and the moving unit 60 (see FIG. 1) are not provided, and the heating unit 30 is secured to a device body (not illustrated in the drawings).

The support roll 82 is formed in a solid cylinder shape whose axial direction coincides with the X direction, and the support roll 82 is rotatably provided at the opposite side of the heating unit 30 in the Z direction with respect to the resin member 12 and the resin member 14. The support roll 82 supports the resin member 12 and the resin member 14 from the lower side in the Z direction.

The pressure applying unit 90 includes four pressure applying rolls 42 and the support member 44 (see FIG. 1) that rotatably supports the four pressure applying rolls 42. The four pressure applying rolls 42 are rotatably provided such that there are two at the heating unit 30 side and two at the opposite side of the heating unit 30 in the Z direction with respect to the resin member 12 and the resin member 14. The two pressure applying rolls 42 at the heating unit 30 side and the two pressure applying rolls 42 at the opposite side of the heating unit 30 are lined up in the Z direction and sandwich the welding target portion 16 of the resin member 12 and the resin member 14 such that the pressure applying rolls 42 may convey the welding target portion 16 in the Y direction.

The cooling unit 50 is configured to cool the four pressure applying rolls 42 by conducting water W through four hollow portions 46. In this way, in the welding device 80, the resin member 12 and the resin member 14 that have been heated by the heating unit 30 are subjected to pressure and cooled by the four pressure applying rolls 42 while being conveyed in the Y direction by the rotation of the four pressure applying rolls 42.

[Operations and Effects]

Next, the operation and effects of the welding device 80 of the second embodiment will be described.

In the welding device 80 and the welding method using the welding device 80, the welding target portion 16 is welded as a result of being sufficiently melted by the heat applied by the heating unit 30 and is solidified. Therefore, the shear strength of the welded portion 18 of the welding target portion 16 may be ensured.

Furthermore, in the welding device 80, expansion in the Z direction accompanying the rise in the temperature of the resin member 12 and the resin member 14 is suppressed by the pressure applied by the pressure applying unit 90. Since at least the surface 12B of the welding target portion 16 is cooled by the cooling unit 50 via the pressure applying rolls 42, the temperature of the surface 12B is kept from becoming higher than the temperature of the welded portion 18 (the welding surfaces 12A and 14A). As a result of these operations, appearance defects such as swelling of the surface 12B of the welding target portion 16 may be reduced. Namely, when welding the resin member 12 and the resin member 14 to each other by heating them with the heating unit 30, defects in the appearance of the welding target portion 16 may be reduced while ensuring the shear strength of the welding portion 18 of the welding target portion 16 compared to a configuration that performs only natural cooling subsequent to the heating.

Furthermore, in the welding device 80, the four pressure applying rolls 42 are disposed as two pairs in the conveyance direction (Y direction) of the resin member 12 and the resin member 14. In other words, since the welding target portion 16 subsequent to the heating by the heating unit 30 is cooled in two stages, appearance defects accompanying the heating of the welding target portion 16 may be further reduced.

### Third Embodiment

Next, an example of a fiber-reinforced thermoplastic resin member welding method and a fiber-reinforced thermoplastic resin member welding device pertaining to a third embodiment will be described. Members and portions that are basically similar to those in the first and second embodiments will be assigned the same reference signs as in the first and second embodiments and description thereof will be omitted.

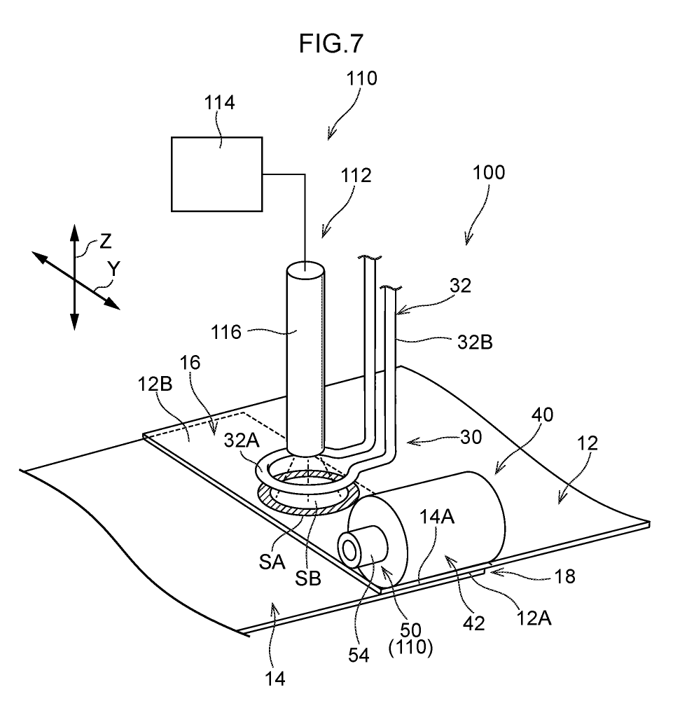

FIG. 7 illustrates a welding device 100 of the third embodiment. The welding device 100 is an example of a fiber-reinforced thermoplastic resin member welding device. The welding device 100 has, for example, a similar configuration to the welding device 20 (see FIG. 1) of the first embodiment except that a cooling unit 110 is provided instead of the cooling unit 50 (see FIG. 1). In FIG. 7 illustrations of the housing member 34 and the power supply 38 (see FIG. 1) are omitted. The cooling unit 110 is an example of a cooling unit. The cooling unit 110 includes the cooling unit 50 and an air blowing unit 112 that serves as an example of an air blowing unit.

The air blowing unit 112 includes a compressor 114 and a nozzle 116 into which air is fed from the compressor 114. The nozzle 116 is formed in a hollow cylinder shape and is disposed with its axial direction coinciding with the Z direction on the inner side of the circle of the coil portion 32A of the coil member 32. As a result, the welding device 100 is configured such that air is blown from the nozzle 116 toward a region SB inside an annular region SA of the welding target portion 16 heated by distribution of current through the coil member 32.

Namely, the welding device 100 is configured such that the surface 12B of the welding target portion 16 is cooled as a result of air being blown from the air blowing unit 112 toward the portion being heated by the heating unit 30. Moreover, the welding device 100 is configured such that, after the surface 12B has been cooled by the air in conjunction with the heating of the welding surface 12A and the welding surface 14A, the pressure applying roll 42 cooled by the cooling unit 50 is brought into contact with the surface 12B.

[Operation and Effects]

Next, the operations and effects of the welding device 100 of the third embodiment will be described.

In the welding device 100 and the welding method using the welding device 100, the welding target portion 16 is welded as a result of being sufficiently melted by the heat applied by the heating unit 30 and is solidified. Therefore, the shear strength of the welded portion 18 of the welding target portion 16 may be ensured.

Furthermore, in the welding device 100, when heating the welding target portion 16, air is blown from the air blowing unit 112 toward the portion being heated by the heating unit 30, whereby the surface 12B of the welding target portion 16 is cooled. As a result, cooling of the surface 12B is started at an earlier time compared to a configuration in which the surface 12B is cooled subsequent to the heating. Thus, the highest temperature that the surface 12B reaches may be lowered. Moreover, expansion in the Z direction accompanying the rise in the temperature of the resin member 12 and the resin member 14 is suppressed by the pressure applied by the pressure applying roll 42 cooled by the cooling unit 50. As a result of these operations, appearance defects such as swelling of the surface 12B of the welding target portion 16 may be reduced. Namely, when welding the resin member 12 and the resin member 14 to each other by heating them with the heating unit 30, defects in the appearance of the welding target portion 16 may be reduced while ensuring the shear strength of the welded portion 18 of the welding target portion 16 compared to a configuration that performs only natural cooling subsequent to the heating.

It will be noted that the disclosure is not limited to the above-described embodiments.

### First Example Modification

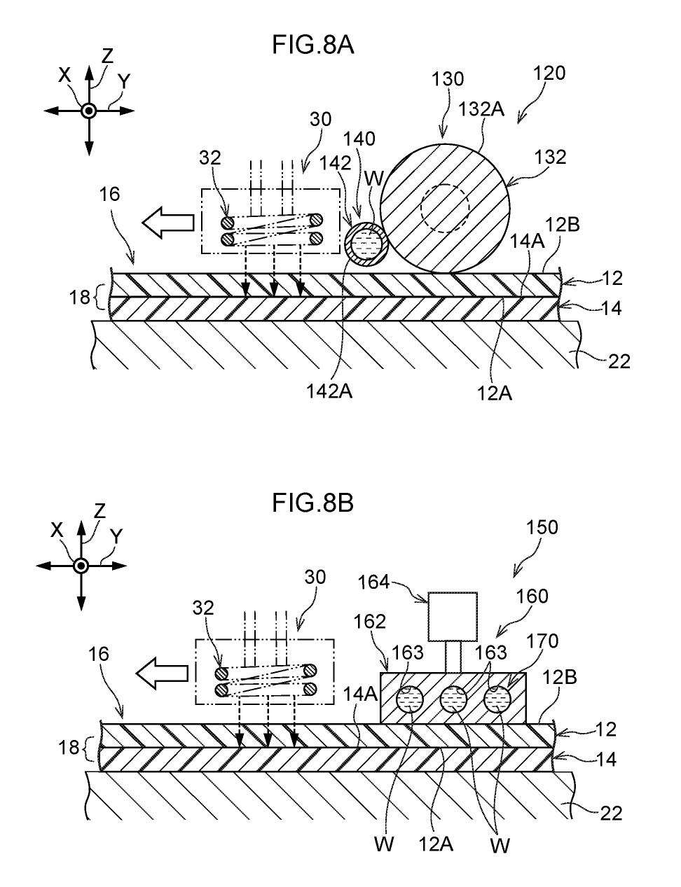

FIG. 8A illustrates a welding device 120 of a first example modification. The welding device 120 has a similar configuration to the welding device 20 (see FIG. 1) except that a pressure applying unit 130 serving as an example of a pressure applying unit and a cooling unit 140 serving as an example of a cooling unit are provided instead of the pressure applying unit 40 and the cooling unit 50.

The pressure applying unit 130 includes a pressure applying roll 132, which serves as an example of a pressure applying member and a pressure rotor, and the support member 44 (see FIG. 1), which supports the pressure applying roll 132. The pressure applying roll 132 is configured as a solid (solid cylinder-shaped) roll in which the hollow portion 46 (see FIG. 2A) of the pressure applying roll 42 (see FIG. 1) is eliminated.

The cooling unit 140 includes a hollow cylinder-like cooling roll 142, the pipe member 52 and the pipe member 54 (see FIG. 1), and the pump 56 (see FIG. 1). The cooling roll 142 is rotatably supported with its axial direction coinciding with the X direction using a bearing (not illustrated in the drawings). Water W is conducted from the pump 56 through the cooling roll 142. An outer peripheral surface 142A of the cooling roll 142 is in contact with an outer peripheral surface 132A of the pressure applying roll 132. The cooling roll 142 is rotated following the rotation of the pressure applying roll 132.

The welding target portion 16 is heated by the heating unit 30, and thereafter the heating unit 30, the pressure applying unit 130, and the cooling unit 140 are moved by the moving unit 60 (see FIG. 1) and the heat of the welding target portion 16 is transmitted to the pressure applying roll 132, whereby the surface 12B of the welding target portion 16 is cooled. Furthermore, the outer peripheral surface 132A of the pressure applying roll 132 to which the heat has been transmitted is cooled due to contact with the outer peripheral surface 142A of the cooling roll 142. In this way, at least the surface 12B of the welding target portion 16 may be cooled by cooling the outer peripheral surface 132A of the pressure applying roll 132 with the cooling roll 142 disposed on the radial direction outer side of the pressure applying roll 132.

### Second Example Modification

FIG. 8B illustrates a welding device 150 of a second example modification. The welding device 150 has a similar configuration to the welding device 20 (see FIG. 1) except that a pressure applying unit 160 serving as an example of a pressure applying unit and a cooling unit 170 serving as an example of a cooling unit are provided instead of the pressure applying unit 40 and the cooling unit 50.

The pressure applying unit 160 includes a pressure applying member 162 and a pressing portion 164 that presses the pressure applying member 162 against the welding target portion 16. The pressure applying member 162 is, for example, made of stainless steel and formed in a cuboid shape. When viewed from the X direction, the cross-sectional shape of the pressure applying member 162 is a rectangular shape whose lengthwise direction coincides with the Y direction and whose widthwise direction coincides with the Z direction. Three hollow portions 163 that run through the pressure applying member 162 in the X direction and are lined up an interval apart from each other in the Y direction are formed in the pressure applying member 162. The pressing portion 164 presses the pressure applying member 162 against the welding target portion 16 after the resin member 12 and the resin member 14 have been disposed on the table 22.

The cooling unit 170 has a similar configuration to the cooling unit 50 (see FIG. 1) except that it is provided with three sets of the pipe member 52 and the pipe member 54 (see FIG. 1). The pipe members 52 and the pipe members 54 are connected to the three hollow portions 163. As a result, the pressure applying member 162 is cooled by the water W conducted from the pump 56 (see FIG. 1).

The welding target portion 16 is heated by the heating unit 30, and thereafter the heating unit 30, the pressure applying unit 160, and the cooling unit 170 are moved by the moving unit 60 (see FIG. 1) and the heat of the welding target portion 16 is transmitted to the pressure applying member 162, whereby the surface 12B of the welding target portion 16 is cooled. Furthermore, the pressure applying member 162 to which the heat has been transmitted is cooled by the water W of the cooling unit 170. In this way, at least the surface 12B of the welding target portion 16 may be cooled using the cuboid-shaped pressure applying member 162.

### Other Example Modifications

The reinforcing fibers are not limited to the carbon fibers CF, and metal fibers, such as iron fibers, or conductive fibers may be used.

The thermoplastic resin is not limited to a polyamide resin. For example, polypropylene resin, polyphenylene sulfide (PPS) resin, polyethylene terephthalate (PET) resin, polybutylene terephthalate (PBT) resin, polycarbonate (PC) resin, acrylic (PMMA) resin, acrylonitrile butadiene styrene (ABS) resin, and thermoplastic epoxy resin may also be used.

The resin member 12 and the resin member 14 to be welded to each other are not limited to panel members. For example, they may be members in which only the welded portion 18 is formed in a tabular shape, such as flange portions of a door panel of a vehicle. Furthermore, the resin member 12 and the resin member 14 may be members with different sizes, shapes, and materials. The number of the fiber-reinforced thermoplastic resin members to be welded to each other is not limited to two and may be three or more. In addition, an intermediate material may also be provided between the plural fiber-reinforced thermoplastic resin members to be welded to each other, in the layering direction thereof.

The pressure applying rolls 42 and 132, and the pressure applying member 162 are not limited to being made of stainless steel and may be configured by another metal such as aluminum or copper. The hollow portion 46 of the pressure applying roll 42 is not limited to a single hollow portion formed in the rotational center portion, and may be plurally formed in concentric circles with an interval in the radial direction. Moreover, a releasable material such as a fluororesin may be used to form a releasable layer on the surfaces of the pressure applying rolls 42 and 132 and the pressure applying member 162.

The coolant is not limited to the water W. For example, liquid nitrogen may also be used.

The heating unit 30, the pressure applying unit 40, the cooling unit 50, and the moving unit 60 are not limited to being disposed at the resin member 12 side, and may be disposed at the resin member 14 side. For example, the resin member 12 may be suctioned and held, and the heating, application of pressure, and cooling may be performed from the resin member 14 side (the lower side in the Z direction). In a case in which the thickness of the resin member 12 and the thickness of the resin member 14 are different and in which the heating unit 30, the pressure applying unit 40, the cooling unit 50, and the moving unit 60 are disposed on one side, the heating unit 30, the pressure applying unit 40, the cooling unit 50, and the moving unit 60 may be disposed on the side of the resin member with the thinner thickness in the Z direction.

In the welding device 20, the heating unit 30, and the pressure applying unit 40 and the cooling unit 50, may be respectively moved by different moving units 60. Furthermore, in the welding device 20, the pressure applying roll 42 may be made solid and the air blowing unit 112 may be provided between the heating unit 30 and the pressure applying roll 42.

Examples of fiber-reinforced thermoplastic resin member welding methods and fiber-reinforced thermoplastic resin member welding device pertaining to embodiments and example modifications of the disclosure have been described above. These embodiments and example modifications may be appropriately combined with each other and used, and may be implemented in a variety of ways in a range that does not depart from the spirit of the disclosure.

What is claimed is:

1. A fiber-reinforced thermoplastic resin member welding method comprising:
heating, by a heating unit, a welding target portion in which a plurality of fiber-reinforced thermoplastic resin members layered on top of each other, each of the plurality of fiber-reinforced thermoplastic resin members including thermoplastic resin as a main composition, and the thermoplastic resin including reinforcing fibers;
applying pressure, by a pressure applying unit, to the welding target portion; and
cooling, by a cooling unit, at least a surface of the welding target portion at the same time as when the welding target portion is being heated by the heating unit or after the welding target portion has been heated by the heating unit.

2. The fiber-reinforced thermoplastic resin member welding method according to claim 1, wherein the cooling comprises cooling the welding target portion by cooling the pressure applying unit by the cooling unit.

3. The fiber-reinforced thermoplastic resin member welding method according to claim 2, wherein
the pressure applying unit comprises a pressure applying member provided with a hollow portion, and
the cooling comprises cooling the hollow portion by the cooling unit.

4. The fiber-reinforced thermoplastic resin member welding method according to claim 1, wherein the cooling comprises cooling the surface of the welding target portion by blowing, by the cooling unit, air toward a portion being heated by the heating unit.

5. The fiber-reinforced thermoplastic resin member welding method according to claim 1, wherein
the welding target portion extends in an intersecting direction intersecting the layering direction of the plurality of fiber-reinforced thermoplastic resin members,
the heating unit, the pressure applying unit, and the cooling unit are disposed at one side of the welding target portion in the layering direction, and
the method further comprises performing the heating of the welding target portion, the application of pressure to the welding target portion, and the cooling of the welding target portion while moving, by a moving unit, the heating unit, the pressure applying unit, and the cooling unit, integrally in the intersecting direction.

6. A fiber-reinforced thermoplastic resin member welding device comprising:
a heating unit that is configured to heat a welding target portion in which a plurality of fiber-reinforced thermoplastic resin members are layered on top of each other, each of the plurality of fiber-reinforced thermoplastic resin members including thermoplastic resin as a main composition, and the thermoplastic resin including reinforcing fibers;
a pressure applying unit that is configured to apply pressure to the welding target portion at the same time as when the welding target portion is being heated by the heating unit or after the welding target portion has been heated by the heating unit; and
a cooling unit that is configured to cool at least a surface of the welding target portion.

7. The fiber-reinforced thermoplastic resin member welding device according to claim 6, wherein
the pressure applying unit comprises a pressure applying member that applies pressure to the welding target portion, and
the cooling unit is configured to cool at least the surface of the welding target portion by cooling the pressure applying member.

8. The fiber-reinforced thermoplastic resin member welding device according to claim 7, wherein
the pressure applying member comprises a pressure applying rotor that is provided with a hollow portion and applies pressure to the welding target portion while rotating, and
the cooling unit comprises a conducting component that is configured to conduct, through the hollow portion, a coolant that cools the pressure applying member.

9. The fiber-reinforced thermoplastic resin member welding device according to claim 6, wherein the cooling unit comprises an air blowing unit that is configured to cool the surface of the welding target portion by blowing air toward a portion being heated by the heating unit.

10. The fiber-reinforced thermoplastic resin member welding device according to claim 6, wherein
the welding target portion extends in an intersecting direction intersecting the layering direction of the plurality of fiber-reinforced thermoplastic resin members,
the heating unit, the pressure applying unit, and the cooling unit are disposed at one side of the welding target portion in the layering direction, and
the device further comprising a moving unit that is configured to move the heating unit, the pressure applying unit, and the cooling unit, integrally in the intersecting direction.
